(19) United States
(12) Patent Application Publication
(10) Pub. No.: US 2021/0094352 A1
(43) Pub. Date: Apr. 1, 2021

(54) PNEUMATIC TIRE

(71) Applicant: TOYO TIRE CORPORATION, Itami-shi (JP)

(72) Inventor: Hirokazu Sakata, Itami-shi (JP)

(73) Assignee: TOYO TIRE CORPORATION, Itami-shi (JP)

(21) Appl. No.: 17/021,178

(22) Filed: Sep. 15, 2020

(30) Foreign Application Priority Data
Oct. 1, 2019 (JP) 2019-181345

(51) Int. Cl. B60C 5/14

(52) U.S. Cl. CPC B60C 5/14; B60C 2005/145; B60C 2005/147

(57) ABSTRACT

A pneumatic tire includes a tread portion, sidewall portions, bead cores, an inner member including side portions and being continuous between the bead cores, a discontinuous ply disposed on an outer side in a tire radial direction of the inner member, and including ply pieces each having an inner end portion disposed in the tread portion, a side portion, and a winding portion wound up on the bead cores, a belt covering inner ends portion of the ply from the outer side in the tire radial direction, first joining members arranged between the inner end portions of the ply pieces and the inner member, and a pair of second joining members arranged between the inner end portions of the ply pieces and the belt, and each including an extending portion extending toward an outer side in a tire width direction beyond an end portion of the belt.

### CROSS-REFERENCE TO RELATED APPLICATIONS

This application claims priority of Japanese Patent Application No.: 2019-181345 filed on Oct. 1, 2019, the content of which is incorporated herein by reference.

### BACKGROUND OF THE INVENTION

### Technical Field

The present invention relates to a pneumatic tire.

### Related Art

The carcass ply of the pneumatic tire disclosed in Japanese Patent Laid-Open No. 2017-109517 includes a first ply continuous between a pair of bead portions, and a discontinuous second ply disposed on an outer side of the first ply in a tire radial direction. The second ply includes a pair of ply pieces extending from a tread portion to one of the pair of bead portions, respectively. In the center of the tread portion, a region where neither of the two ply pieces exists, that is, a hollow portion is provided. The hollow portion of the second ply is intended to achieve two types of performances basically conflicting with each other. One type of performance is rigidity (which contributes to improving steering stability) and cut resistance, and the other type of performance is weight reduction and reduction of rolling resistance due to the weight reduction.

### SUMMARY

A carcass ply including a hollow portion (hereinafter, also referred to as “hollow ply”) is attached to a surface on an outer side in a tire radial direction of an inner member disposed inside the hollow ply. The hollow ply attached to the surface on the outer side in the tire radial direction of the inner member may be displaced from the inner member during the manufacturing process.

For example, during the manufacturing process of a pneumatic tire, a hollow ply is attached to the surface on the outer side in the tire radial direction of the inner member wound around a cylindrical molding drum. Then, bead cores are attached to both end portions of the inner member and the hollow ply in a tire width direction. Since the diameter of the bead core is smaller than that of the inner member, the bead core is attached to the inner member and the hollow ply in a state where both end portions thereof are reduced in diameter. At this time, the position of the inner end portion of the hollow ply with respect to the inner member may be displaced from the regular position to a side portion side (inner side in the tire radial direction).

The displacement of the hollow ply with respect to the inner member may reduce the rigidity of the pneumatic tire without applying a desired tension to the hollow ply.

However, the pneumatic tire disclosed in Japanese Patent Laid-Open No. 2017-109517 does not consider the displacement of the hollow ply with respect to the inner member during manufacturing of the pneumatic tire.

An object of the present invention is to provide a pneumatic tire in which the displacement of a carcass ply including a hollow portion from the inner member is suppressed.

One aspect of the present invention provides a pneumatic tire including: a tread portion; a pair of sidewall portions respectively extending to an inner side in a tire radial direction from both ends of the tread portion; a pair of bead cores respectively arranged at end portions of the pair of sidewall portions on the inner side in the tire radial direction; an inner member including a central portion located on the inner side in the tire radial direction of the tread portion and a pair of side portions respectively extending from both ends of the central portion to the inner side in the tire radial direction, and being continuous between the pair of bead cores; a discontinuous ply disposed on an outer side in the tire radial direction with respect to the inner member, and including a pair of ply pieces each of that has an inner end portion located in the tread portion, a side portion that extends from the inner end portion to the inner side in the tire radial direction, and a winding portion that is provided continuously with the side portion and wound up on any one of the pair of bead cores; a belt disposed on the outer side in the tire radial direction of the ply, and covering the inner end portion of each of the pair of ply pieces from the outer side in the tire radial direction; a pair of first joining members each of that is arranged between an inner surface in the tire radial direction of the inner end portion of each of the pair of ply pieces and the inner member, and that respectively join the pair of ply pieces and the inner member; and a pair of second joining members each of that is arranged between an outer surface in the tire radial direction of the inner end portion of each of the pair of ply pieces and the belt, and that respectively join the pair of ply pieces and the belt.

The “inner end portion of each of the pair of ply pieces” as mentioned herein each include a portion that extends to an outer side in the tire width direction from the innermost end portion of each of the pair of ply pieces and is continuous with the side portion.

The ply includes a pair of ply pieces and is discontinuous. That is, between the inner end portions of the pair of ply pieces, there is a hollow portion where no ply exists. By adopting a ply having such a hollow portion, it is possible to reduce the weight as compared with the case where the ply is one continuous ply.

The first joining member is disposed between the inner member and the inner end portion of the ply piece. Thus, the pair of ply pieces are discontinuous between the inner end portions, so that the displacement of the ply pieces with respect to the inner member, which occurs during molding, can be suppressed.

Since the second joining member is disposed between the end portion of the belt on the outer side in the tire width direction and the ply, the separation of the belt from the ply is suppressed, and the durability can be improved.

Each of the pair of second joining members may include an extending portion that extends toward an outer side in a tire width direction beyond an end portion of the belt on the outer side in the tire width direction.

With this configuration, the end portion of the second joining member does not overlap the end portion of the belt. As a result, as compared with the case where the end portion of the second joining member and the end portion of the belt overlap, stress concentration at the end portion of the belt on the outer side in the tire width direction can be suppressed.

Each of the first joining member and each the second joining member may be integrally formed.

With this configuration, it is possible to suppress the displacement of the ply with respect to the inner member and to suppress the separation of the belt at the end portion on the outer side in the tire width direction with a simple structure using one joining member. Since the two joining members are integrally formed, the number of parts can be reduced.

The inner member may be an inner liner.

With this configuration, the displacement of the ply piece with respect to the inner liner during the molding of the pneumatic tire can be suppressed.

The inner member may be another ply.

With this configuration, it is possible to suppress the displacement of the second ply with respect to the first ply during molding of the pneumatic tire.

The width of the extending portion of each of the pair of second joining members may be set to be not less than 5% and not more than 30% of the belt width.

With this configuration, the width of the extending portion of the second joining member can be set to a width that can suppress stress concentration at the end portion of the belt without causing an unnecessary increase in weight.

Each of the pair of ply pieces includes a joining surface portion that is joined to the inner member via the first joining member, and the width of each of the pair of joining surface portions may be set to a width of not less than 3% and not more than 25% of the width of the ply piece.

With this configuration, the pair of ply pieces can be joined to the inner member with sufficient joining strength without unnecessarily increasing the weight.

Each of the first joining member and the second joining member may have an adhesive force of 500 gf or more.

With this configuration, it is possible to secure good adhesion to the inner member of the pair of ply pieces and the belt.

According to the present invention, in a pneumatic tire including a carcass ply having a hollow portion, the carcass ply having the hollow portion can be prevented from being displaced with respect to the inner member, so that steering stability is improved.

### BRIEF DESCRIPTION OF THE DRAWINGS

The foregoing and the other features of the present invention will become apparent from the following description and drawings of an illustrative embodiment of the invention in which:

FIG. 1 is a meridional cross-sectional view of a pneumatic tire according to an embodiment of the present invention;

FIG. 2 is a meridional cross-sectional view of a tread portion of the pneumatic tire according to the embodiment of the present invention and the periphery thereof; and

FIG. 3 is an enlarged view of part III in FIG. 1.

### DETAILED DESCRIPTION OF EMBODIMENTS

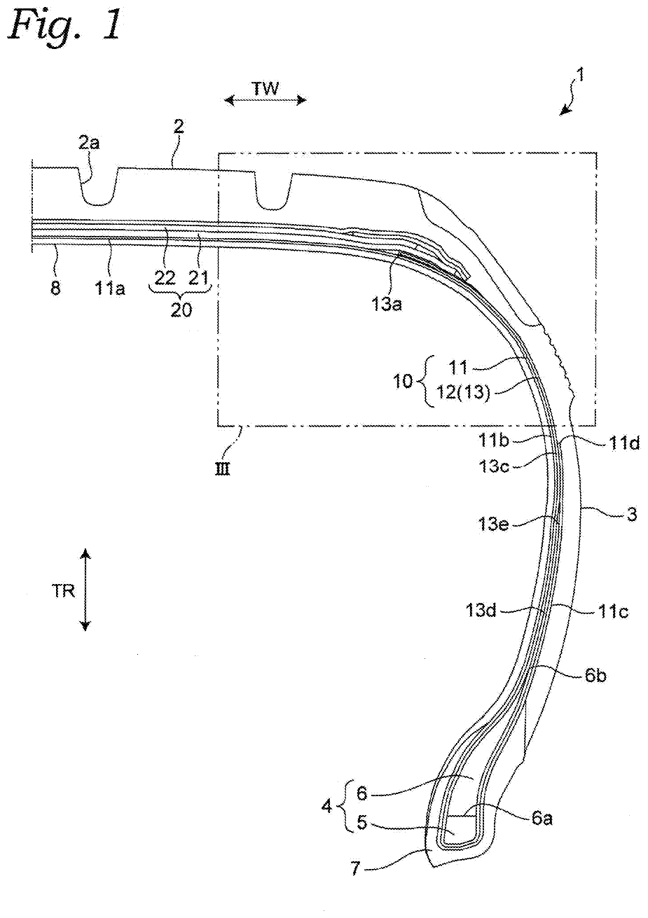

FIGS. 1 to 3 show a rubber pneumatic tire (hereinafter referred to as a tire) 1 according to an embodiment of the present invention.

The tire 1 includes a tread portion 2, a pair of sidewall portions 3, and a pair of ring-shaped bead portions 4.

The tread portion 2 extends in a tire width direction (shown by reference symbol TW in FIG. 1). A groove 2a is provided on a surface of the tread portion 2, that is, a tread surface.

The pair of sidewall portions 3 respectively extend from both ends of the tread portion 2 to the inner side in the tire radial direction (reference symbol TR in FIG. 1).

The pair of bead portions 4 are respectively arranged at the end portions of the pair of sidewall portions 3 on the inner side in the tire radial direction. Each bead portion 4 includes a bead core 5 and a bead filler 6. The bead core 5 includes a large number of steel wires bundled in a ring shape. The bead filler 6 has a ring shape and is made of rubber that is harder than the rubber forming the tread portion 2 and the sidewall portion 3. The bead filler 6 includes a base end 6a disposed adjacent to the outer side of the bead core 5 in the tire radial direction, and a tip end 6b opposite to the base end 6a, and extends in a tapered shape from the base end 6a toward the tip end 6b outward in the tire radial direction. Each bead portion 4 includes a strip rubber 7 provided so as to enclose the bead core 5 and the bead filler 6.

The tire 1 includes a carcass 10 laid in a toroidal shape between the bead portions 4. In the present embodiment, the carcass 10 includes a first carcass ply (hereinafter, referred to as “first ply”) 11 as an inner member, and a second carcass ply (hereinafter, referred to as “second ply”) 12. The second ply 12 is a ply having a hollow portion 13b, while the first ply 11 is a normal ply having no hollow portion. The first and second plies 11 and 12 will be described in detail later. An inner liner 8 is provided on the inner side of the carcass 10, that is, on the innermost peripheral surface of the tire 1.

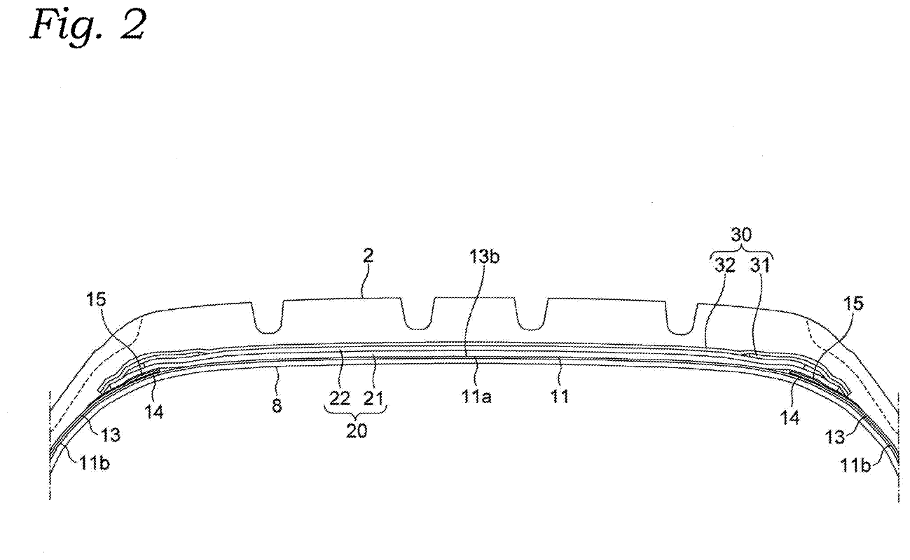

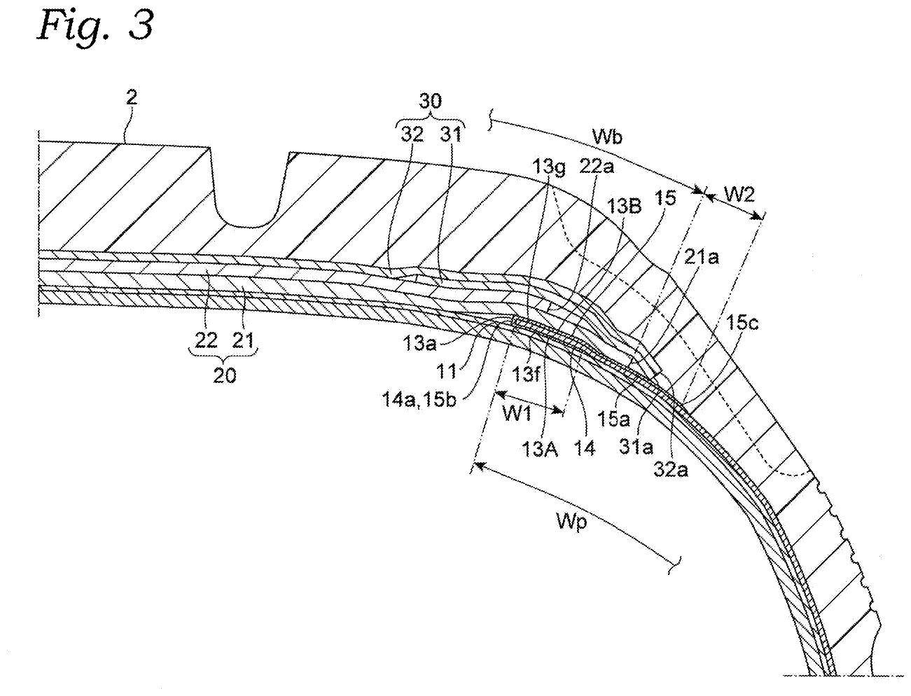

Referring to FIGS. 2 and 3, an endless belt layer 20 is provided in the tread portion 2, more specifically, between the carcass 10 and the tread portion 2. In this embodiment, the belt layer 20 includes two belts 21 and 22. The belt 21 is disposed adjacent to the outer side of the carcass 10 in the tire radial direction, and the belt 22 is disposed adjacent to the outer side of the belt 21 in the tire radial direction. Further, in the present embodiment, the dimension of the lower layer belt 21 in the tire width direction is larger than the dimension of the upper layer belt 22 in the tire width direction, and the end portion 21a of the belt 21 is located on an outer side in the tire width direction than the end portion 22a of the belt 22. The belts 21 and 22 are formed by coating a belt cord made of steel or organic fiber with rubber. The belt layer 20 may be composed of one belt, or may be provided with three or more belts.

An endless cap layer 30 is provided adjacent to the outer side of the belt layer 20 in the tire radial direction. The cap layer 30 of the present embodiment includes a pair of narrow edge plies 31 that directly cover either of the end portions 21a and 22a of the belts 21 and 22, respectively. Further, the cap layer 30 of the present embodiment includes a wide cap ply 32 which is disposed adjacent to the outer side of the edge ply 31 in the tire radial direction and covers the entire belts 21 and 22 including the end portions 21a and 22a with one sheet. The cap layer 30 may include one ply or three or more plies. Further, the cap layer 30 may be omitted.

Hereinafter, the first and second plies 11 and 12 forming the carcass 10 will be described.

As described above, the first ply 11 is a single ply, but the second ply 12 is a discontinuous ply having the hollow portion 13b as described above, and is composed of a pair of ply pieces 13. Each of the ply pieces 13 of the first ply 11 and the second ply 12 is a strip-shaped sheet in which a plurality of cords arranged in parallel at intervals are covered with rubber.

The ply pieces 13 of the first ply 11 and the second ply 12 may have the same modulus (stress generated when a constant strain is applied) or may have different moduli. Further, the ply pieces 13 of the first ply 11 and the second ply 12 may have the same breaking strength (tensile load at which breaking occurs) or may have different breaking strengths. A case where the ply pieces 13 of the first ply 11 and the second ply 12 have different moduli and breaking strengths will be described in detail later.

The first ply 11 includes a central portion 11a, a pair of side portions 11b, and a pair of winding portions 11c. The central portion 11a is disposed on the inner side of the tread portion 2 in the tire radial direction. The pair of side portions 11b are respectively arranged in the sidewall portion 3 so as to extend inward in the tire radial direction from both ends of the central portion 11a in the tire width direction. The pair of winding portions 11c are continuous with the end portions of the pair of side portions 11b on the inner side in the tire radial direction, respectively. Each winding portion 11c is wound up from the inside in the tire width direction to the outside with respect to one of the pair of bead cores 5, and terminates at the sidewall portion 3. The end portion 11d of the winding portion 11c is located on the outer side in the tire radial direction than the tip end 6b of the bead filler 6 and on the inner side in the tire radial direction than the tread portion 2.

The second ply 12 is disposed adjacent to the first ply 11 on the outer side in the tire radial direction, and is a discontinuous ply composed of a pair of ply pieces 13. The ply piece 13 has an inner end portion 13a disposed between the belt layer 20 and the central portion 11a of the first ply 11. A first joining tape (first joining member) 14 is interposed between the inner end portion 13a and the first ply 11. A second joining tape (second joining member) 15 is interposed between the inner end portion 13a and the belt layer 20. The position of the inner end portion 13a of the ply piece 13 in the tire width direction is set in a region on the outer side in the tire width direction in the tread portion 2, more specifically, in a region on the inner side in the tire width direction than any of the end portions 21a and 22a of the belts 21 and 22 constituting the belt layer 20. The hollow portion 13b is provided in a region of the tread portion 2 in the center in the tire width direction, more specifically, in a region between the inner end portions 13a of the pair of ply pieces 13. In this hollow portion 13b, the second ply 12 does not exist, but only the central portion 11a of the first ply 11 exists.

The ply piece 13 includes a side portion 13c extending from the inner end portion 13a to the inner side in the tire radial direction, and a winding portion 13d provided continuous with the side portion 13c. The side portion 13c is disposed adjacent to the outer side of the side portion 11b of the first ply 11 in the tire width direction. The winding portion 13d is wound up from the inside in the tire width direction to the outside with respect to the bead core 5, and terminates at the sidewall portion 3. The winding portion 13d is disposed so as to be overlapped on the inner side of the winding portion 11c of the first ply 11 in the tire width direction, and is disposed on the outer side of the bead filler 6 in the tire radial direction so as to be overlapped on the outer side of the side portion 13c in the tire radial direction. The end portion 13e of the winding portion 13d is located on the outer side in the tire radial direction than the tip end 6b of the bead filler 6 and on the inner side in the tire radial direction than the end portion 11d of the winding portion 11c of the first ply 11.

As described above, the pneumatic tire 1 includes a pair of first joining tapes (first joining member) 14 that joins one of the inner end portions 13a of the pair of ply pieces 13 of the second ply 12 and the first ply 11, respectively, and a pair of second joining tape (second joining member) 15 that joins one of the inner end portions 13a of the pair of ply pieces 13 of the second ply 12 and the belt 21, respectively.

The first and second joining tapes 14 and 15 are made of rubber, and in order to secure the joining strength of the second ply 12 to the first ply 11 and the joining strength of the belt layer 20 to the second ply 12, it is preferable to have an adhesive force of 500 gf or more.

As shown most clearly in FIG. 3, each of the pair of ply pieces 13 of the second ply 12 includes a joining surface portion 13f joined to the first ply 11 via the first joining member 14. The joining surface portion 13f is provided on a surface 13A on the inner side in the tire radial direction of a portion that extends in the tire width direction from the inner end portions 13a of each of the pair of ply pieces 13 and is continuous with the side portion 13c. The first joining tape 14 is disposed between the joining surface portion 13f of each of the pair of ply pieces 13 and the first ply 11 and joins them together. In the present embodiment, the end portion 14a of the first joining tape 14 on the inner side in the tire width direction is disposed at substantially the same position as the inner end portion 13a of the ply piece 13 of the second ply 12. The width of the first joining tape 14 (width W1 of the joining surface portion 13f) is set to a predetermined dimension that provides the adhesive force necessary for suppressing the displacement of the ply piece 13 with respect to the first ply 11 by the first joining tape 14. For example, the width W1 of the joining surface portion 13f of each of the pair of ply pieces 13 of the second ply 12 joined to the first ply 11 via the first joining tape 14 may be set to a width of not less than 3% and not more than 25% of the width Wp of the ply piece 13.

Each of the pair of ply pieces 13 of the second ply 12 includes a joining surface portion 13g joined to the belt layer 20 via the second joining member 15. The joining surface portion 13g is provided on a surface 13B on the outer side in the tire radial direction of a portion that extends from the inner end portion 13a of each of the pair of ply pieces 13 in the tire width direction and is continuous with the side portion 13c. The second joining tape 15 is disposed between the joining surface portion 13g of each of the pair of ply pieces 13 and the belt 21 of the belt layer 20 and joins them together.

The second joining tape 15 has an extending portion 15a that extends to the outer side in the tire width direction than the end portions 21a and 22a of the belt layer 20. In the present embodiment, the end portion 15b of the second joining tape 15 on the inner side in the tire width direction is disposed at substantially the same position as the inner end portion 13a of the ply piece 13 of the second ply 12. The end portion of the second joining tape 15 on the outer side in the tire width direction is constituted by the end portion 15c of the extending portion 15a on the outer side in the tire width direction. The extending portion 15a is set to extend to the outer side in the tire width direction than the end portions 21a and 22a of the belt layer 20 on the outer side in the tire width direction and the end portions 31a and 32a of the cap layer 30 on the outer side in the tire width direction. For example, the width W2 of the extending portion 15a may be set to a width of not less than 5% and not more than 30% of the width Wb of the belt 21.

The end portion 15b of the second joining tape 15 on the outer side in the tire width direction is disposed at a position where the end portions 21a and 22a of the belt layer on the outer side in the tire width direction and the end portions 31a and 32a of the cap layer 30 on the outer side in the tire width direction are displaced from each other.

In this embodiment, the first joining tape 14 and the second joining tape 15 are integrally formed. The first joining tape 14 and the second joining tape 15 are continuously formed at the end portions 14a and 15b on the inner side in the tire width direction. The first joining tape 14 and the second joining tape 15 may be configured separately.

Next, the features of the pneumatic tire of this embodiment will be described.

The second ply 12 is a discontinuous ply including a pair of ply pieces 13, and between the inner end portions 13a of the pair of ply pieces 13, there is a hollow portion 13b where no ply exists. By adopting the second ply 12 having such a hollow portion 13b, it is possible to reduce the weight as compared with the case where the second ply 12 is one continuous ply.

Since the pair of first joining tapes 14 are arranged between the first ply 11 and each of the pair of ply pieces 13 of the second ply 12, it is possible to suppress the displacement of the ply piece 13 with respect to the first ply 11 that occurs during molding due to the fact that the pair of ply pieces 13 are discontinuous between the inner end portions 13a of the pair of ply piece 13. For example, when the bead core 5 having a smaller diameter than the first ply 11 and the ply piece 13 is attached from both end portions side of the first ply 11 and the ply piece 13 in the tire width direction, it is possible to suppress the displacement of the ply piece 13 of the second ply 12 with respect to the first ply 11, which may occur when the first ply 11 and the second ply 12 are expanded and bonded to the belt layer 20, when the first and second plies 11 and 12 are wound up with respect to the bead core 5.

Since the second joining tape 15 is disposed between the end portions 21a and 22a of the belt layer 20 on the outer side in the tire width direction and the ply piece 13 of the second ply 12, separation of the end portions 21a and 22a of the belt layer 20 from the ply piece 13 of the second ply 12 is suppressed, and durability can be improved.

As described above, according to the present embodiment, in the pneumatic tire 1 including the second ply 12 having the hollow portion 13b, the displacement of the second ply 12 having the hollow portion 13b from the first ply 11 can be suppressed.

As described above, since each of the pair of second joining tapes 15 includes the extending portion 15a that extends to the outer side in the tire width direction beyond the end portions 21a and 22a of the belt layer 20 on the outer side in the tire width direction, the end portion 15c of the second joining tape 15 on the outer side in the tire width direction does not overlap the end portions 21a and 22a of the belt layer 20 on the outer side in the tire width direction. Thereby, as compared with the case where the end portion 15c of the second joining tape 15 and the end portions 21a and 22a of the belt layer 20 overlap, stress concentration at the end portions 21a and 22a of the belt layer 20 on the outer side in the tire width direction can be suppressed.

As described above, since the first joining tape 14 and the second joining tape 15 are integrally formed, with a simple structure of one joining tape, the displacement of the ply piece 13 of the second ply 12 with respect to the first ply 11 can be suppressed, and the separation of the belt layer 20 at the end portions 21a and 22a on the outer side in the tire width direction can be suppressed. Since two joining tapes are integrally formed, the number of parts can be reduced.

As described above, the width W2 of the extending portion 15a of each of the pair of second joining tapes 15 is set to a width of not less than 5% and not more than 30% of the width Wb of the belt 21, so that the end portions 21a and 22a of the belt layer 20 and the end portion 15c of the second joining tape 15 are arranged so as to be displaced from each other. As a result, stress concentration caused by overlapping the end portions 21a and 22a of the belt layer 20 and the end portion 15c of the second joining tape 15 is suppressed.

As described above, since the width W1 of the joining surface portion 13f of each of the pair of ply pieces 13 of the second ply 12 that is joined to the first ply 11 via the first joining tape 15 is set to a width of not less than 3% and not more than 25% of the width Wp of the ply piece 13, the ply piece 13 of the second ply 12 can be joined to the first ply 11 with sufficient joining strength.

Next, a case where the moduli and the breaking strengths of the first ply 11 and the ply piece 13 of the second ply 12 are made different will be described.

The modulus of the first ply 11 may be lower than the modulus of the ply piece 13 of the second ply 12. In a carcass ply, generally, the lower the modulus, the lighter the weight, and the higher the modulus, the heavier the weight. The second ply 12 has a hollow portion 13b, while the first ply 11 has a central portion 11a in the tread portion 2. Compared with the side portion 11b of the first ply 11 and the ply piece 13 of the second ply 12, the central portion 11a of the first ply 11 contributes less to the improvement in rigidity and the cut resistance. Compared with the ply piece 13 of the second ply 12, the first ply 11 having such a central portion 11a has a low modulus, and thus is relatively lightweight, thereby further reducing the weight without impairing the rigidity and the cut resistance.

The breaking strength of the first ply 11 may be lower than the breaking strength of the ply piece 13 of the second ply 12. In the carcass ply, generally, the lower the breaking strength, the lighter the weight, and the higher the breaking strength, the heavier the weight. The second ply 12 has a hollow portion 13b, while the first ply 11 has a central portion 11a in the tread portion 2. Compared with the side portion 11b of the first ply 11 and the ply piece 13 of the second ply 12, the central portion 11a of the first ply 11 contributes less to the improvement in rigidity and the cut resistance. By making the first ply 11 having such a central portion 11a have a lower breaking strength than the ply piece 13 of the second ply 12 and therefore a relatively lighter weight, the weight can be further reduced without impairing the rigidity and the cut resistance.

By making at least one of the cord material, the cord diameter, the number of ends, the rubber hardness, and the rubber thickness different, the modulus of the first ply 11 can be set lower than the modulus of the ply piece 13 of the second ply 12, alternatively, the breaking strength of the first ply 11 can be set lower than the breaking strength of the ply piece 13 of the second ply 12.

The cord diameter, the number of ends, the rubber hardness, and the rubber thickness generally have the following tendencies. First, the larger the cord diameter, the higher the modulus and the breaking strength. Also, the larger the number of ends, the higher the modulus and the breaking strength. Furthermore, the higher the rubber hardness, the higher the modulus and the breaking strength. Furthermore, the thicker the rubber, the higher the modulus and the breaking strength.

Regarding the cord material, the modulus is higher in the order of metal (steel), aramid, rayon, polyester, and nylon. In addition, regarding the cord material, the breaking strength is higher in the order of metal (steel), aramid, nylon, polyester, and rayon.

The present invention is not limited to the embodiment, and various modifications can be made. For example, the pneumatic tire 1 may further include, in addition to the first ply 11 and the second ply 12, a ply having a hollow portion similar to the second ply 12 or a normal ply similar to the first ply 11. Further, there may be a plurality of joining tapes (joining members) for joining the ply piece 13 of the second ply 12 to the first ply 11. Further, there may be a plurality of joining tapes (joining members) for joining the end portions 21a and 22a of the belt layer 20 to the ply piece 13 of the second ply.

Further, for example, the pneumatic tire is described as a configuration including the first ply 11 as the inner member and the second ply 12 as the ply including the pair of ply pieces, but without the second ply, the first ply 11 may be configured as a ply having a hollow portion. In this case, if the inner liner 8 is configured as an inner member, it is possible to suppress the displacement of the first ply 11 having the hollow portion with respect to the inner liner 8 during molding.

What is claimed is:

1. A pneumatic tire comprising:
a tread portion;
a pair of sidewall portions respectively extending to an inner side in a tire radial direction from both ends of the tread portion;
a pair of bead cores respectively arranged at end portions of the pair of sidewall portions on the inner side in the tire radial direction;
an inner member including a central portion located on the inner side in the tire radial direction of the tread portion and a pair of side portions respectively extending from both ends of the central portion to the inner side in the tire radial direction, and being continuous between the pair of bead cores;
a discontinuous ply disposed on an outer side in the tire radial direction with respect to the inner member, and including a pair of ply pieces each of that has an inner end portion located in the tread portion, a side portion that extends from the inner end portion to the inner side in the tire radial direction, and a winding portion that is provided continuously with the side portion and wound up on any one of the pair of bead cores;
a belt disposed on the outer side in the tire radial direction of the ply, and covering the inner end portion of each of the pair of ply pieces from the outer side in the tire radial direction;
a pair of first joining members each of that is arranged between an inner surface in the tire radial direction of the inner end portion of each of the pair of ply pieces and the inner member, and that respectively join the pair of ply pieces and the inner member; and
a pair of second joining members each of that is arranged between an outer surface in the tire radial direction of the inner end portion of each of the pair of ply pieces and the belt, and that respectively join the pair of ply pieces and the belt.

2. The pneumatic tire according to claim 1, wherein each of the pair of second joining members includes an extending portion that extends toward an outer side in a tire width direction beyond an end portion of the belt on the outer side in the tire width direction.

3. The pneumatic tire according to claim 2, wherein a width of the extending portion of each of the pair of second joining members is set to be not less than 5% and not more than 30% of a width of the belt.

4. The pneumatic tire according to claim 1, wherein each of the first joining members and each of the second joining members are integrally formed.

5. The pneumatic tire according to claim 2, wherein each of the first joining members and each of the second joining members are integrally formed.

6. The pneumatic tire according to claim 3, wherein each of the first joining members and each of the second joining members are integrally formed.

7. The pneumatic tire according to claim 1, wherein the inner member is an inner liner.

8. The pneumatic tire according to claim 2, wherein the inner member is an inner liner.

9. The pneumatic tire according to claim 3, wherein the inner member is an inner liner.

10. The pneumatic tire according to claim 4, wherein the inner member is an inner liner.

11. The pneumatic tire according to claim 5, wherein the inner member is an inner liner.

12. The pneumatic tire according to claim 6, wherein the inner member is an inner liner.

13. The pneumatic tire according to claim 1, wherein the inner member is another ply.

14. The pneumatic tire according to claim 2, wherein the inner member is another ply.

15. The pneumatic tire according to claim 3, wherein the inner member is another ply.

16. The pneumatic tire according to claim 4, wherein the inner member is another ply.

17. The pneumatic tire according to claim 5, wherein the inner member is another ply.

18. The pneumatic tire according to claim 6, wherein the inner member is another ply.

19. The pneumatic tire according to claim 1, wherein
each of the pair of ply pieces includes a joining surface portion joined to the inner member via the first joining member, and
a width of the joining surface portion is set to be not less than 3% and not more than 25% a width of each of the pair of ply pieces.

20. The pneumatic tire according to claim 1, wherein each of the first joining members and each of the second joining members have an adhesive force of 500 gf or more.
